(19) United States
(12) Patent Application Publication
(10) Pub. No.: US 2005/0149729 A1
(43) Pub. Date: Jul. 7, 2005

(54) Method to support XML-based security and key management services in a pre-boot execution environment

(76) Inventors: Vincent J. Zimmer, Federal Way, WA (US); Michael A. Rothman, Gig Harbor, WA (US)

Correspondence Address: R. Alan Burnett;BLAKELY, SOKOLOFF, TAYLOR & ZAFMAN LLP, Seventh Floor, 12400 Wilshire Boulevard, Los Angeles, CA, 90025, US

(21) Appl. No.: 10/746,919

(22) Filed: Dec. 24, 2003

(51) Int. Cl. H04L 9/00

(52) U.S. Cl. 713/168

(57) ABSTRACT

Methods and systems to support XML-based security and key management services in a pre-boot execution environment. During pre-boot, XML console in and console out interfaces are loaded, and corresponding API's are published to enable use of the interfaces by various firmware and software components. A network stack is set up to enable XML content received at the network interface to be forwarded to the XML console in interface and XML content provided at the XML content out interface to be sent out via the network interface. Security operations may then be performed to authenticate a client system hosting the XML interfaces, to authenticate remote servers to which the client system may communicate with, and to validate boot images provided to the computer system. Key management services are also supported.

### FIELD OF THE INVENTION

The field of invention relates generally to computer systems and, more specifically but not exclusively relates to techniques for supporting XML-based security and key management services in a pre-boot execution environment.

### BACKGROUND INFORMATION

The pre-boot phase of a computer system is generally considered to occupy the timeframe between when computer system initialization begins and an operating system (OS) begins to boot. Unlike during operating system runtime, there are limited resources available during the pre-boot phase. As a result, the support for interacting with the computer system during pre-boot, setting policies, gathering information, and performing security measures is generally poor, if even available.

In today's computing environments, it is often advantageous to configure computers connected to enterprise networks and the like to boot operating system images that are stored on a network. While this aids flexibility and configuration control for system administrators, it leaves open the possibility for system corruption of misuse. For example, system corruption could occur if a rogue network boot server was able to penetrate the network (or someone would intentionally connect such a server to an network) and host an OS image containing malicious code, such as a virus or Trojan. One example of misuse relates to unauthorized operating system use. Typically, operating system licenses for a given OS version are often purchased for a particular number of users by the enterprise. If these licenses are used for network booting of the operating system, there needs to be a mechanism to limit the number of concurrent users of the license. Ideally, this would be done with some sort of attestation and authentication mechanism.

In order to perform attestation and authentication operations, there needs to be a facility for interaction between two machines (e.g., boot client and a boot server). Currently, some pre-boot execution environments support Unicode-based console interfaces that provided terse access to the pre-boot environment and related operations. The console interfaces include the ConIn( ) and ConOut( ) functions. These two functions provide rudimentary access to the pre-boot environment via unicode text input and output, respectively. This greatly limits the type of attestation and authentication operations that may be preformed during the pre-boot.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a schematic diagram illustrating an architecture for implementing XML-based security and key management services in a pre-boot execution environment, according to one embodiment of the invention;

FIG. 2 is a flowchart illustrating operations and logic for configuring XML-based console services and setting up security and key management services during a computer system pre-boot phase, according to one embodiment of the invention;

FIG. 3 is a schematic diagram illustrating the various execution phases that are performed in accordance with the extensible firmware interface (EFI) framework in response to a system restart;

FIG. 4 is a block schematic diagram illustrating various components of the EFI system table that is configured and populated during the pre-boot phase;

FIG. 5 is a schematic diagram illustrating a pictorial view of a document object model (DOM) tree;

FIG. 6 is a schematic diagram pictorially illustrating processing and interactions between a XML file and an application

FIG. 7 is a schematic diagram illustrating the logical object hierarchy described by the DOM tree of FIG. 5;

FIG. 8 is a diagram of a code listing for a signature element in accordance with the XML Signature and Syntax Specification (XML-SIG) schema.

FIG. 9 is a diagram of a code listing for a manifest element in accordance with the XML-SIG schema;

FIG. 10a is a flowchart illustrating operations performed during generation of a XML-SIG reference element;

FIG. 10b is a flowchart illustrating operations performed during generation of generation of a SignatureValue over a SignedInfo XML-SIG value;

FIG. 11a is a flowchart illustrating operations performed during reference validation in accordance with the XML-SIG standard;

FIG. 11b is a flowchart illustrating operations performed during signature validation in accordance with the XML-SIG standard;

FIG. 12 is a schematic diagram illustrating an architecture corresponding to the Tier0 <ds:RetrievalMethod> XML-SIG service;

FIG. 13 is a schematic diagram illustrating an architecture corresponding to an exemplary implementation of an XML-SIG Tier 1 Locate service;

FIG. 14 is a schematic diagram illustrating an architecture corresponding to an exemplary implementation of a XML-SIG Tier 2 key validation service;

FIG. 15a is a schematic diagram illustrating various message exchanges and operations performed to authenticate a client with a trust service, according to one embodiment of the invention;

FIG. 15b is a schematic diagram illustrating various message exchanges and operations performed to authenticate a client with a trust service, wherein a trusted platform module (TPM) is used to generate attestation data, according to one embodiment of the invention;

FIG. 16 is a schematic diagram illustrating various message exchanges and operations performed to authenticate a boot image downloaded from a remote boot server, according to one embodiment of the invention;

FIG. 17 is a flowchart illustrating operation performed to generate an XML-SIG message, according to one embodiment of the invention;

FIG. 18 is a flowchart illustrating operation performed during processing of a received XML-SIG message, according to one embodiment of the invention; and

FIG. 19 is a schematic diagram illustrating an exemplary computer system on which aspects of the embodiments described herein may be practiced.

### DETAILED DESCRIPTION OF PREFERRED EMBODIMENTS

Embodiments of methods to support XML-based security measures and key management services in pre-boot execution environments and apparatus for performing the methods are described herein. In the following description, numerous specific details are set forth, such as embodiments implemented using the EFI framework, to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

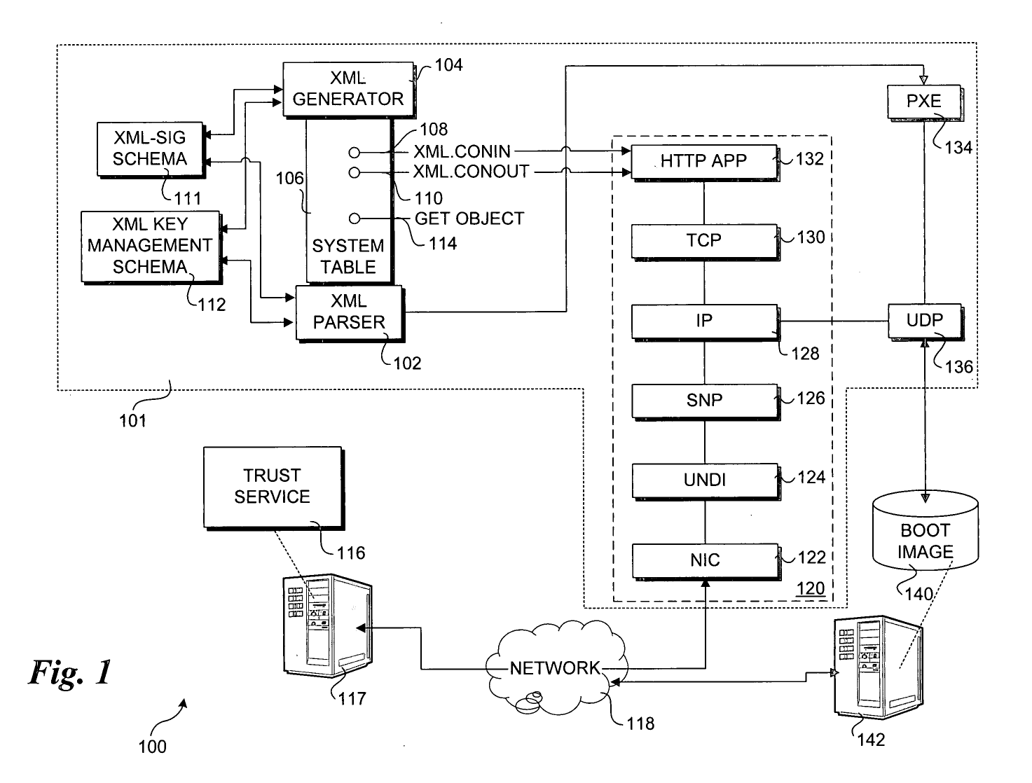

Embodiments are disclosed herein to enable support for XML-based security measures and key management services during pre-boot operations. An XML-based console I/O (input/output) architecture 100 that may be implemented to support these features in accordance with one embodiment of the invention is shown in FIG. 1. Architecture 100 is implemented via an extensible firmware framework known as the Extensible Firmware Interface (EFI) framework (specifications and examples of which may be found at http://developer.intel.com/technology/efi). EFI is a public industry specification that describes an abstract programmatic interface between platform firmware and shrink-wrap operation systems or other custom application environments. The EFI framework include provisions for extending BIOS functionality beyond that provided by the BIOS code stored in a platform's BIOS device (e.g., flash memory). More particularly, EFI enables firmware, in the form of firmware modules and drivers, to be loaded from a variety of different resources, including primary and secondary flash devices, option ROMs, various persistent storage devices (e.g., hard disks, CD ROMs, etc.), and even over computer networks. Further details of the EFI framework are discussed below.

At the heart of architecture 100 is an XML parser 102, an XML generator 104, and an EFI system table 106 that includes XML-based console input (XML ConIn( )) and console output (XML ConOut( )) interfaces 108 and 110, all hosted by a local system 101. The XML parser 102 is used to parse XML documents structured in accordance with an XML digital signature (XML-SIG) schema 111 and a key management schema 112. A Get Object interface 114 is also provided to retrieve various system security objects.

In accordance with one aspect of architecture 100, a mechanism is provided security measures for local system 101 via a trust service 116 running on a remote host 117. The remote host 117 is connected to the local system via a network 118. In turn, communications over network 118 are facilitated by a network stack 120 that includes a network interface controller (NIC) 122, a universal network device interface (UNDI) 124, a simple network protocol (SNP) layer 126, and Internet Protocol (IP) layer 128, an Transmission Control Protocol (TCP) layer 130, and an Hypertext Transport Protocol (HTTP) application 132.

Architecture 100 also includes components relating to system boot operations. These components include a PXE (pre-boot execution environment) driver 134, and a Universal Datagram Protocol (UDP) component 136. These components may be used to retrieve boot components stored as a boot image 140. The boot image may be stored on remote host 117 (which would then be called a boot server), or on another server coupled to network 118, as depicted by a boot server 142.

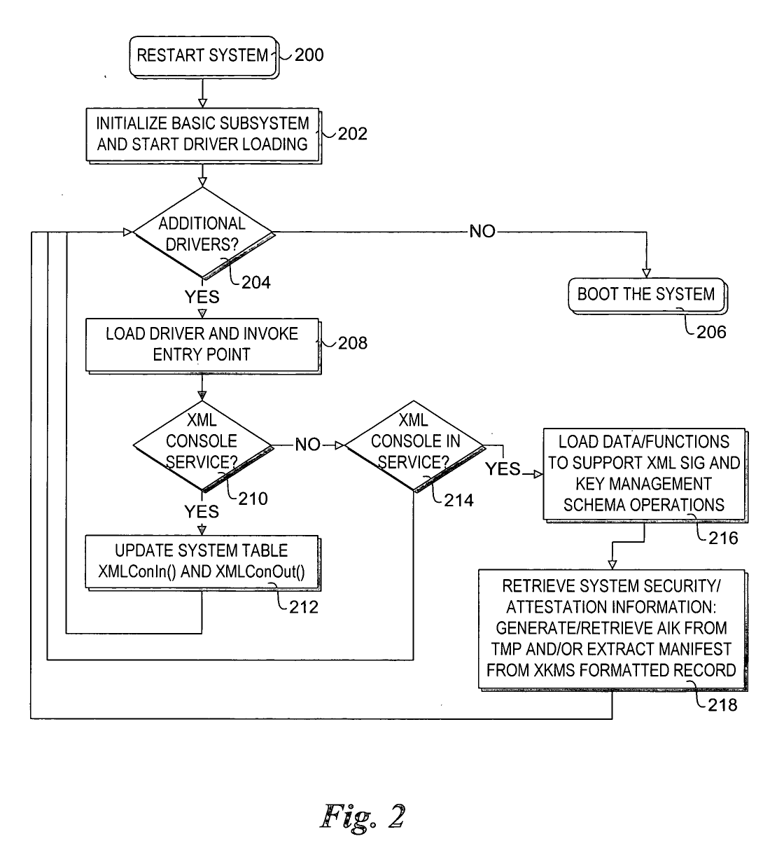

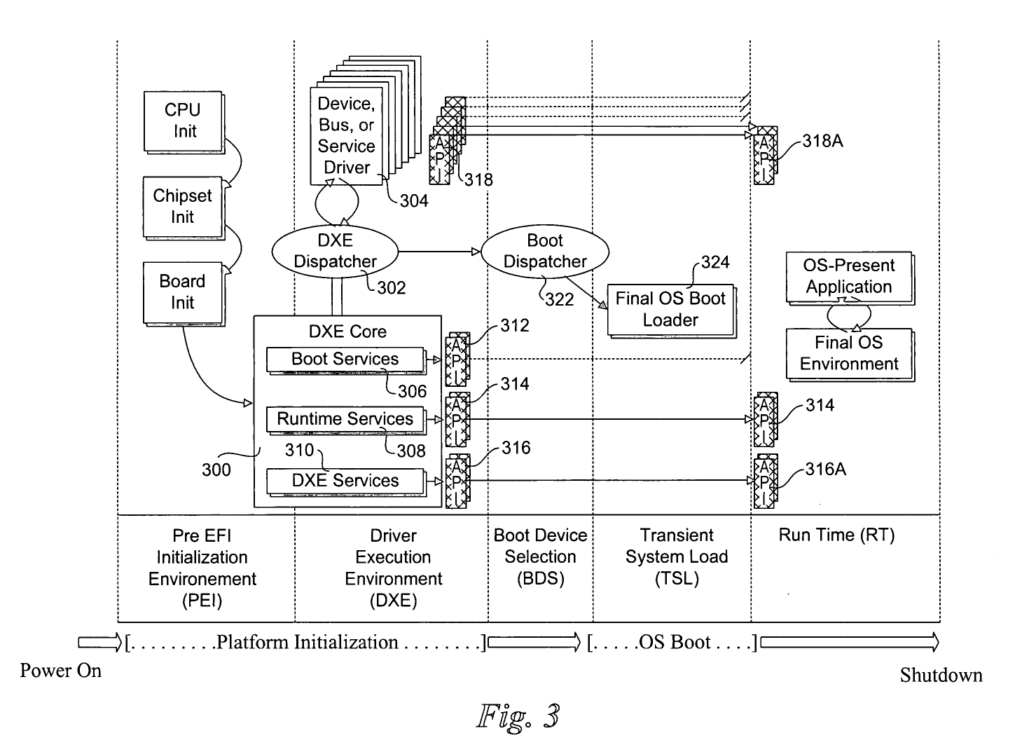

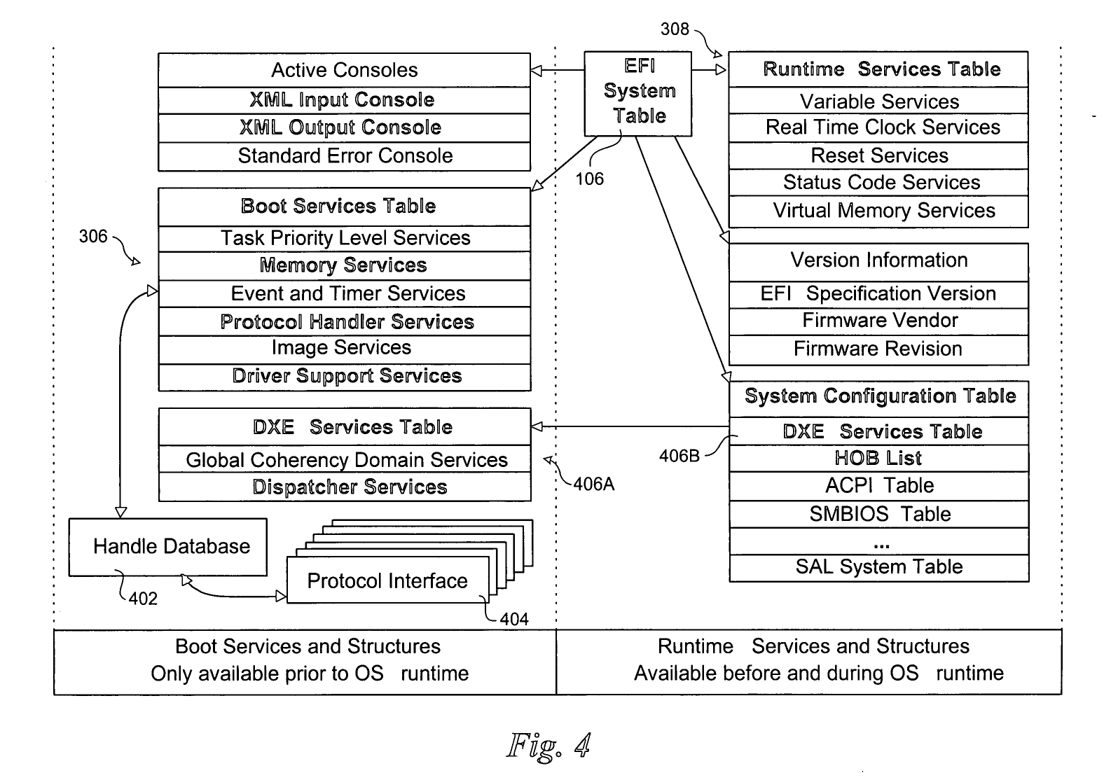

A flowchart illustrating operations and logic performed during the pre-boot phase of a computer system to initialize XML-based console interfaces and security provisions according to one embodiment are shown in FIG. 2. The process begins with a system restart event in a start block 200. In block 202, the basic firmware subsystem is initialized and driver loading is begun. Further details of this process for an EFI-based framework are discussed below with reference to FIGS. 3 and 4.

As depicted by a decision block 204, the following operations are performed for each driver that is loaded, until there are no more drivers to load, at which point the system is booted in a block 206. In a block 208, the driver is loaded and its entry point is invoked. A determination is then made in a decision block 210 to whether the driver is an XML console service. If it is, the EFI system table 106 is updated with the XML ConIn( ) and XML ConOut( ) interfaces (as appropriate) in a block 212. If not, the logic returns to entry decision block 204 to process the next driver.

If the answer to decision block 210 is NO, the logic proceeds to a decision block 214, wherein a determination is made to whether driver supports an XML security service. If it does, data and/or function to support the operations of XML signature schema 111 and key management schema 112 are loaded in a block 216. In general, the schema data may mirror portions of the schemas described in the corresponding XML Signature and Syntax Specification (XML-SIG) and XML Key Management Specification (XKMS) described in further detail below, or may be configured in a different manner, such as in a compressed format. The corollary functions correspond to the algorithms used for encryption and decryption, as well as other operations related to the XML-SIG and XKMS usage.

In a block 218, security and/or attestation data for the system is retrieve. These data are used to identify the system for security purposes. In one embodiment, the system hosts a Trusted Platform Module (TPM) that is used to generate an Attestation Identity Key (AIK) that is used to identify a system in a trusted environment. In another embodiment, the security/attestation information is stored in a manifest formatted as an XKMS record. The manifest may be already stored on the system, or loaded from a trusted service or the like during the pre-boot. In yet another embodiment, a combination of an AIK and XKMS manifest are employed. Further details of each of these security/attestation mechanisms are discussed below.

Further details of one embodiment of the EFI framework are shown in FIGS. 3 and 4. FIG. 3 shows an event sequence/architecture diagram used to illustrate operations performed by a platform under the framework in response to a cold boot restart event (e.g., a power off/on reset). The process is logically divided into several phases, including a pre-EFI Initialization Environment (PEI) phase, a Driver Execution Environment (DXE) phase, a Boot Device Selection (BDS) phase, a Transient System Load (TSL) phase, and an operating system runtime (RT) phase. The phases build upon one another to provide an appropriate run-time environment for the OS and platform.

The PEI phase provides a standardized method of loading and invoking specific initial configuration routines for the processor (CPU), chipset, and motherboard. The PEI phase is responsible for initializing enough of the system to provide a stable base for the follow on phases. Initialization of the platforms core components, including the CPU, chipset and main board (i.e., motherboard) is performed during the PEI phase. This phase is also referred to as the “early initialization” phase. Typical operations performed during this phase include the POST (power-on self test) operations, and discovery of platform resources. In particular, the PEI phase discovers memory and prepares a resource map that is handed off to the DXE phase. The state of the system at the end of the PEI phase is passed to the DXE phase through a list of position independent data structures called Hand Off Blocks (HOBs).

The DXE phase is the phase during which most of the system initialization is performed. The DXE phase is facilitated by several components, including the DXE core 300, the DXE dispatcher 302, and a set of DXE drivers 304. The DXE core 300 produces a set of Boot Services 306, Runtime Services 308, and DXE Services 310. The DXE dispatcher 302 is responsible for discovering and executing DXE drivers 304 in the correct order. The DXE drivers 304 are responsible for initializing the processor, chipset, and platform components as well as providing software abstractions for console and boot devices. These components work together to initialize the platform and provide the services required to boot an operating system. The DXE and the Boot Device Selection phases work together to establish consoles and attempt the booting of operating systems. The DXE phase is terminated when an operating system successfully begins its boot process (i.e., the BDS phase starts). Only the runtime services and selected DXE services provided by the DXE core and selected services provided by runtime DXE drivers are allowed to persist into the OS runtime environment. The result of DXE is the presentation of a fully formed EFI interface.

The DXE core is designed to be completely portable with no CPU, chipset, or platform dependencies. This is accomplished by designing in several features. First, the DXE core only depends upon the HOB list for its initial state. This means that the DXE core does not depend on any services from a previous phase, so all the prior phases can be unloaded once the HOB list is passed to the DXE core. Second, the DXE core does not contain any hard coded addresses. This means that the DXE core can be loaded anywhere in physical memory, and it can function correctly no matter where physical memory or where Firmware segments are located in the processor's physical address space. Third, the DXE core does not contain any CPU-specific, chipset specific, or platform specific information. Instead, the DXE core is abstracted from the system hardware through a set of architectural protocol interfaces. These architectural protocol interfaces are produced by DXE drivers 304, which are invoked by DXE Dispatcher 302.

The DXE core produces an EFI System Table 106 and its associated set of Boot Services 306 and Runtime Services 308, as shown in FIG. 4. The DXE Core also maintains a handle database 402. The handle database comprises a list of one or more handles, wherein a handle is a list of one or more unique protocol GUIDs (Globally Unique Identifiers) that map to respective protocols 404. A protocol is a software abstraction for a set of services. Some protocols abstract I/O devices, and other protocols abstract a common set of system services. A protocol typically contains a set of APIs and some number of data fields. Every protocol is named by a GUID, and the DXE Core produces services that allow protocols to be registered in the handle database. As the DXE Dispatcher executes DXE drivers, additional protocols will be added to the handle database including the architectural protocols used to abstract the DXE Core from platform specific details.

The Boot Services comprise a set of services that are used during the DXE and BDS phases. Among others, these services include Memory Services, Protocol Handler Services, and Driver Support Services: Memory Services provide services to allocate and free memory pages and allocate and free the memory pool on byte boundaries. It also provides a service to retrieve a map of all the current physical memory usage in the platform. Protocol Handler Services provides services to add and remove handles from the handle database. It also provides services to add and remove protocols from the handles in the handle database. Addition services are available that allow any component to lookup handles in the handle database, and open and close protocols in the handle database. Support Services provides services to connect and disconnect drivers to devices in the platform. These services are used by the BDS phase to either connect all drivers to all devices, or to connect only the minimum number of drivers to devices required to establish the consoles and boot an operating system (i.e., for supporting a fast boot mechanism). In contrast to Boot Services, Runtime Services are available both during pre-boot and OS runtime operations.

The DXE Services Table includes data corresponding to a first set of DXE services 406A that are available during pre-boot only, and a second set of DXE services 406B that are available during both pre-boot and OS runtime. The pre-boot only services include Global Coherency Domain Services, which provide services to manage I/O resources, memory mapped I/O resources, and system memory resources in the platform. Also included are DXE Dispatcher Services, which provide services to manage DXE drivers that are being dispatched by the DXE dispatcher.

The services offered by each of Boot Services 306, Runtime Services 308, and DXE services 310 are accessed via respective sets of API's 312, 314, and 316. The API's provide an abstracted interface that enables subsequently loaded components to leverage selected services provided by the DXE Core.

After DXE Core 300 is initialized, control is handed to DXE Dispatcher 302. The DXE Dispatcher is responsible for loading and invoking DXE drivers found in firmware volumes, which correspond to the logical storage units from which firmware is loaded under the EFI framework. The DXE dispatcher searches for drivers in the firmware volumes described by the HOB List. As execution continues, other firmware volumes might be located. When they are, the dispatcher searches them for drivers as well.

There are two subclasses of DXE drivers. The first subclass includes DXE drivers that execute very early in the DXE phase. The execution order of these DXE drivers depends on the presence and contents of an a priori file and the evaluation of dependency expressions. These early DXE drivers will typically contain processor, chipset, and platform initialization code. These early drivers will also typically produce the architectural protocols that are required for the DXE core to produce its full complement of Boot Services and Runtime Services.

The second class of DXE drivers are those that comply with the EFI 1.10 Driver Model. These drivers do not perform any hardware initialization when they are executed by the DXE dispatcher. Instead, they register a Driver Binding Protocol interface in the handle database. The set of Driver Binding Protocols are used by the BDS phase to connect the drivers to the devices required to establish consoles and provide access to boot devices. The DXE Drivers that comply with the EFI 1.10 Driver Model ultimately provide software abstractions for console devices and boot devices when they are explicitly asked to do so.

Any DXE driver may consume the Boot Services and Runtime Services to perform their functions. However, the early DXE drivers need to be aware that not all of these services may be available when they execute because all of the architectural protocols might not have been registered yet. DXE drivers should use dependency expressions to guarantee that the services and protocol interfaces they require are available before they are executed.

The DXE drivers that comply with the EFI 1.10 Driver Model do not need to be concerned with this possibility. These drivers simply register the Driver Binding Protocol in the handle database when they are executed. This operation can be performed without the use of any architectural protocols. In connection with registration of the Driver Binding Protocols, a DXE driver may “publish” an API by using the InstallConfigurationTable function. This published drivers are depicted by API's 318. Under EFI, publication of an API exposes the API for access by other firmware components. The API's provide interfaces for the Device, Bus, or Service to which the DXE driver corresponds during their respective lifetimes.

The BDS architectural protocol executes during the BDS phase. The BDS architectural protocol locates and loads various applications that execute in the pre-boot services environment. Such applications might represent a traditional OS boot loader, or extended services that might run instead of, or prior to loading the final OS. Such extended pre-boot services might include setup configuration, extended diagnostics, flash update support, OEM value-adds, or the OS boot code. A Boot Dispatcher 320 is used during the BDS phase to enable selection of a Boot target, e.g., an OS to be booted by the system.

During the TSL phase, a final OS Boot loader 322 is run to load the selected OS. Once the OS has been loaded, there is no further need for the Boot Services 306, and for many of the services provided in connection with DXE drivers 304 via API's 318, as well as DXE Services 406A. Accordingly, these reduced sets of API's that may be accessed during OS runtime are depicted as API's 316A, and 318A in FIG. 3.

In accordance with aspects of the embodiments disclosed herein, the pre-boot/boot framework of FIG. 3 may be implemented to host the architecture 100 of FIG. 1 to support XML data exchange via the XML ConIn( ) and ConOut( ) interfaces 108 and 110. The various components of architecture 100 may be embodied as DXE drivers and EFI applications, with interfaces (i.e., API's) made accessible via EFI system table 106. As a result, XML processing is enabled during the pre-boot phase, defining a mechanism for supporting XML-based security measures described below.

XML, a subset of the Standard Generalized Markup Language (SGML), is the universal format for data on the World Wide Web (WWW). Using XML, users can create customized tags, enabling the definition, transmission, validation, and interpretation of data between applications and between individuals or groups of individuals. XML is a complementary format to HTML and is similar to the Hypertext Markup Language (HTML), as both contain markup symbols to describe the contents of a page or file. A difference, however, is that HTML is primarily used to specify how the text and graphic images of a Web page are to be displayed or interacted with. XML does not have a specific application but can be designed for a wider variety of applications

In accordance with the DOM building operations of blocks 1702 and 1708 below, an XML document is converted to an object model tree data structure comprising as a document object model (DOM) tree. In general, this operation may be performed using one of many commercially available XML parsers; in one embodiment the XML parser is embodied as a firmware component corresponding to XML parser 102.

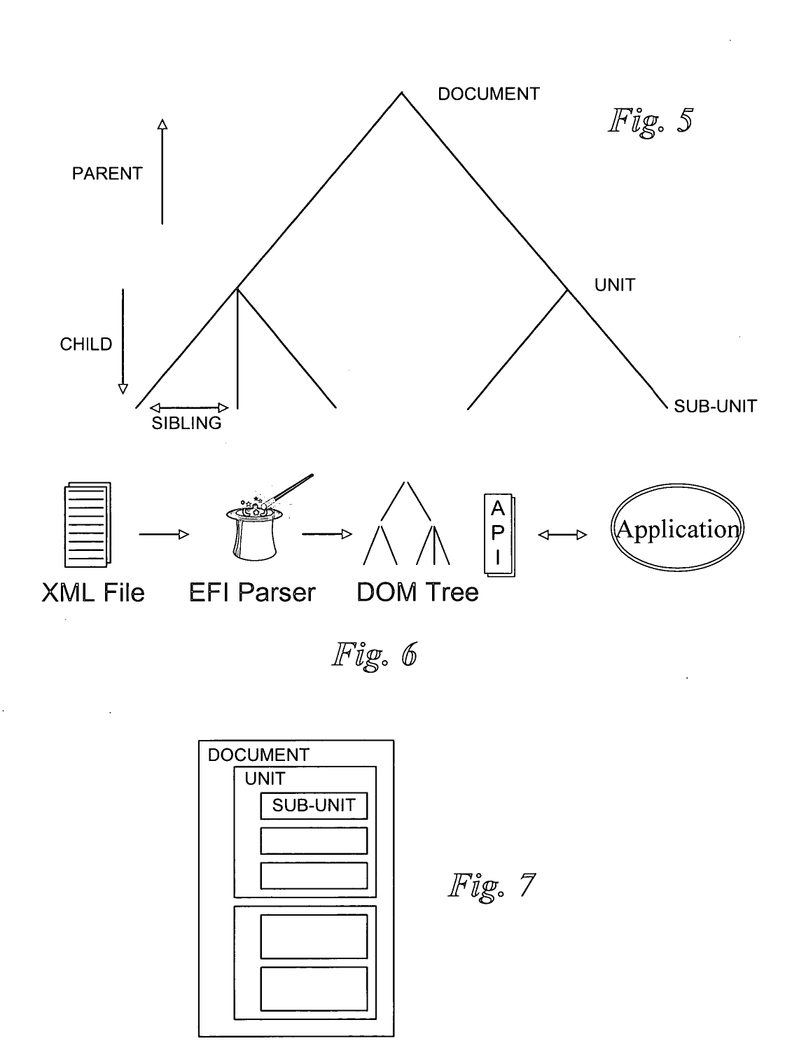

In brief, an object model contains information pertaining to objects, along with properties of those objects. Such information is typically illustrated as a tree-like data structure comprising a plurality of nodes, wherein a parent node may have one or more child nodes, and the lowest level nodes are known as leaf nodes, such as shown in FIG. 5. This parallels the natural hierarchy of well-formed XML documents. As with HTML, XML documents comprise a plurality of XML elements defined by start- and end-tag pairs, wherein each XML element contains all of the data defined between its tags. This data may typically include other XML elements, such that XML elements may be nested within other XML elements. This creates a natural tree-like hierarchy, with parent-child relationships that are similar to those used in object models. For example, FIG. 5 shows an exemplary DOM tree architecture, while the corresponding object model hierarchy is depicted in FIG. 7. FIG. 6 pictorially illustrates operations to provide data contained in an XML document (i.e., file) to an application.

In accordance with the foregoing similarities between XML document structures and object models, the XML parser 102 generates a DOM tree by parsing the XML elements, extracting the inherent parent-child relationships and any corresponding data for each node. For example, XML documents typically contain a plurality of XML elements nested a various levels in the document's tree hierarchy, as defined by respective XML element start- and end-tag pairs. An object tree provides a logical representation of the components of a DOM tree that would result from parsing the XML of an XML document. Each object and any associated properties in an object tree representation is derived from a corresponding XML element in an XML listing, wherein the object's position in the object tree structure directly corresponds to the hierarchical position of its corresponding XML element in the XML listing. As will be recognized by those skilled in the XML arts, the actual DOM tree would provide additional information including interfaces that enable methods to manipulate the objects to which the interfaces correspond, as well as other DOM nodes and objects. These components of the DOM tree may or may not be used by the embodiments of the invention described herein, depending on the particularities of the implementation.

According to further aspects of this specification, XML schemas may be employed to support XML-based security measures. XML schemas are used to define datatypes and corresponding structures. Schemas are normally thought of in terms of databases. A schema is generally defined as the organization or structure of a database, and is often derived from a data model defining the structure and relationship between data elements. A schema typically comprises a structure using some sort of controlled vocabulary that names items of data, and lists any constraints that may apply (e.g., datatype, legal/illegal values, special formatting, etc.). The relationships between data items (the objects of data models) are also an important part of any schema.

In the context of XML, formal specifications for schemas are defined by the World Wide Web Consortium (W3C) organization. The three relevant specification documents include three parts: XML Schema Part 0: Partner, XML Schema Part 1: Structures, and XML Schema Part 2: Datatypes. The current versions of these specifications are respectively available at http://www.w3.org/TR/xmlschema-0/, http://www.w3.org/TR/xmlschema-1/, and http://www.w3.org/TR/xmlschema-2/, all dated May 2, 2001.

XML Security Specifications

Embodiments of the invention may be deployed using schemas and methods defined by standardized XML security specifications. In particular, the applicable standards include the XML-Signature Syntax and Processing specification (XML-SIG) (W3C recommendation, Feb. 12, 2003)), which is available http://www.w3.org/TR/xmldsig-core/, and the XML Key Management Specification (XKMS) (W3C note, Mar. 30, 2001), which is available at http://www.w3.org/TR/xxms/. The XML-Signature Syntax and Processing specification concerns syntax and processing relating to XML security measures (i.e., digital signatures, key processing, etc.), while the XML Key Management Specification concerns aspects of security schemes under a networked environment. A third aspect, XML encryption, as yet to be standardized, but rather is a work in progress at this time.

In one embodiment, security measures are provided via the use of XML-based signatures. An excellent overview of XML-based signatures, summarized below, is contained in an article entitled “Introduction to XML Digital Signatures” by Ed Simon, Paul Madsen, and Carlisle Adams and available at http://www.xml.com/pub/a/2001/08/08/xmldsig.html. The globally-recognized method for secure transactions is to use digital certificates to enable the encryption and digital signing of the exchanged data. The term “public key infrastructure” (PKI) is used to describe the processes, policies, and standards that govern the issuance, maintenance, and revocation of the certificates, public, and private keys that the encryption and signing operations require.

Public key cryptography allows users of an insecure network, like the Internet, to exchange data with confidence that it will be neither modified nor inappropriately accessed. This is accomplished through a transformation of the data according to an algorithm parameterized by a pair of numbers—the so-called public and private keys. Each participant in the exchange has such a pair of keys. They make the public key freely available to anyone wishing to communicate with them, and they keep the other key private and protected. Although the keys are mathematically related, if the cryptosystem has been designed and implemented securely, it is computationally infeasible to derive the private key from knowledge of the public key.

The nature of the relation between the public and private keys is such that a cryptographic transformation encoded with one key can only be reversed with the other. This defining feature of public key encryption technology enables confidentiality because a message encrypted with the public key of a specific recipient can only be decrypted by the holder of the matching private key (i.e., the recipient, if they have properly protected access to the private key). Even if intercepted by someone else, without the appropriate private key, this third party will be unable to decrypt the message.

The special relationship between public and private keys also enables functionality that has no parallel in symmetric cryptography; namely, authentication (ensuring that the identity of the sender can be determined by anyone) and integrity (ensuring that any alterations of the message content can be easily spotted by anyone). These features support non-repudiation (ensuring the origin or delivery of data in order to protect the sender against false denial by the recipient that the data has been received or to protect the recipient against false denial by the sender that the data has been sent) to provide electronic messages with a mechanism analogous to signatures in the paper world, that is, a digital signature.

To create a digital signature for a message, the data to be signed is transformed by an algorithm that takes as input the private key of the sender. Because a transformation determined by the sender's private key can only be undone if the reverse transform takes as a parameter the sender's public key, a recipient of the transformed data can be confident of the origin of the data (the identity of the sender). If the data can be verified using the sender's public key, then it must have been signed using the corresponding private key (to which only the sender should have access).

For signature verification to be meaningful, the verifier must have confidence that the public key does actually belong to the sender (otherwise an impostor could claim to be the sender, presenting her own public key in place of the real one). A certificate, issued by a Certification Authority, is an assertion of the validity of the binding between the certificate's subject and her public key such that other users can be confident that the public key does indeed correspond to the subject who claims it as her own.

Largely due to the performance characteristics of public-key algorithms, the entire message data is typically not itself transformed directly with the private key. Instead a small unique thumbprint of the document, called a “hash” or “digest”, is transformed. Because the hashing algorithm is very sensitive to any changes in the source document, the hash of the original allows a recipient to verify that the document was not altered (by comparing the hash that was sent to them with the hash they calculate from the document they received). Additionally, by transforming the hash with their private key, the sender also allows the recipient to verify that it was indeed the sender that performed the transformation (because the recipient was able to use the sender's public key to “undo” the transformation). The hash of a document, transformed with the sender's private key, thereby acts as a digital signature for that document and can be transmitted openly along with the document to the recipient. The recipient verifies the signature by taking a hash of the message and inputting it to a verification algorithm along with the signature that accompanied the message and the sender's public key. If the result is successful, the recipient can be confident of both the authenticity and integrity of the message.

XML signatures are digital signatures designed for use in XML transactions. The standard defines a schema for capturing the result of a digital signature operation applied to arbitrary (but often XML) data. Like non-XML-aware digital signatures (e.g., PKCS), XML signatures add authentication, data integrity, and support for non-repudiation to the data that they sign. However, unlike non-XML digital signature standards, the XML signature has been designed to both account for and take advantage of the Internet and XML.

A fundamental feature of an XML Signature is the ability to sign only specific portions of the XML tree rather than the complete document. An XML signature can sign more than one type of resource. For example, a single XML signature might cover character-encoded data (HTML), binary-encoded data (a JPG), XML-encoded data, and a specific section of an XML file. Signature validation requires that the data object that was signed be accessible. The XML signature itself will generally indicate the location of the original signed object. This reference can: be referenced by a URI within the XML signature; reside within the same resource as the XML signature (the signature is a sibling); be embedded within the XML signature (the signature is the parent); or have its XML signature embedded within itself (the signature is the child).

XML Signatures are applied to arbitrary digital content (data objects) via an indirection. Data objects are digested, the resulting value is placed in an element (with other information) and that element is then digested and cryptographically signed. XML digital signatures are represented by the Signature element which has the following structure (where “?” denotes zero or one occurrence; “+” denotes one or more occurrences; and “*” denotes zero or more occurrences):

Signatures are related to data objects via URIs (uniform reference identifiers. Within an XML document, signatures are related to local data objects via fragment identifiers. Such local data can be included within an enveloping signature or can enclose an enveloped signature. Detached signatures are over external network resources or local data objects that reside within the same XML document as sibling elements; in this case, the signature is neither enveloping (signature is parent) nor enveloped (signature is child). Since a Signature element (and its Id attribute value/name) may co-exist or be combined with other elements (and their IDs) within a single XML document, care should be taken in choosing names such that there are no subsequent collisions that violate the ID uniqueness validity constraint.

The required <SignedInfo> element 800 is the information that is actually signed. Core validation of <SignedInfo> consists of two mandatory processes: validation of the signature over <SignedInf>o and validation of each Reference digest within SignedInfo. Note that the algorithms used in calculating the <SignatureValue> element 802 are also included in the signed information while the <SignatureValue> element is outside <SignedInfo> element 800. The <SignatureValue> element 802 contains the value of the encrypted digest of the <SignedInfo> element 800.

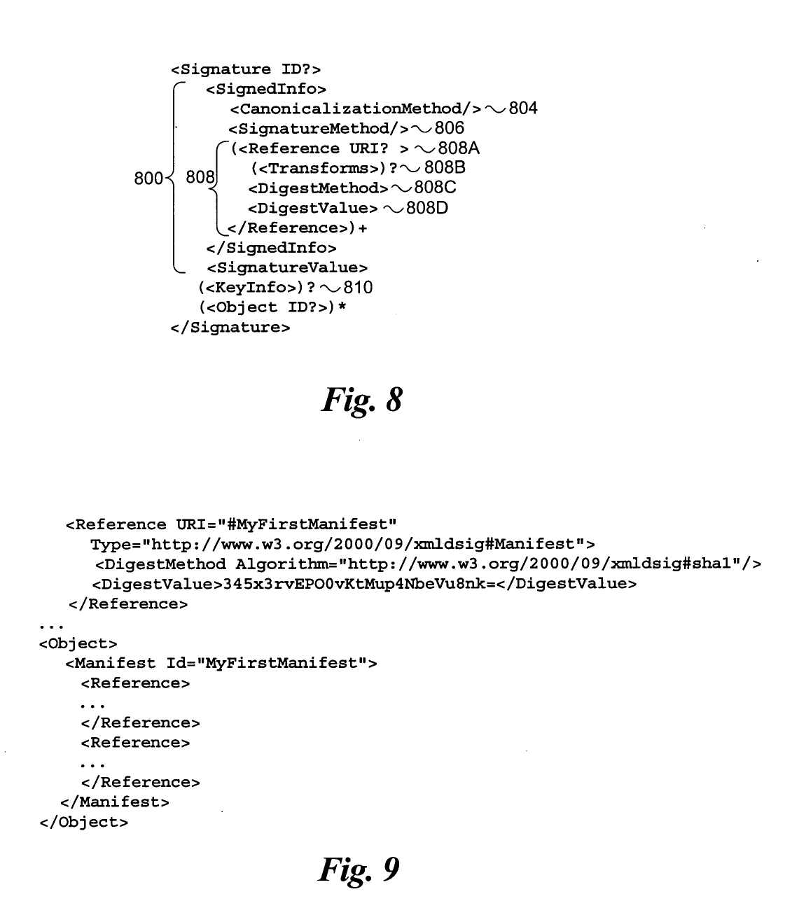

The <CanonicalizationMethod/> element 804 defines the algorithm that is used to canonicalize the <SignedInfo> element 800 before it is digested as part of the signature operation. The canonical form is the simplest form of the XML content (i.e., configured as a sequence of elements without white space or formatting—note that the example shown in FIG. 8 is not in canonical form for clarity).

The <SignatureMethod/> element 806 specifies the algorithm that is used to convert the canonicalized SignedInfo into the SignatureValue. It is a combination of a digest algorithm and a key dependent algorithm and possibly other algorithms such as padding, for example RSA-SHA1. The algorithm names are signed to resist attacks based on substituting a weaker algorithm. To promote application interoperability a set of signature algorithms are required by the specification, although their use is at the discretion of the signature creator. The specification also specifies Additional algorithms as recommended or optional, while the design also permits arbitrary user specified algorithms.

Each <Reference> element 808 includes the digest method and resulting digest value calculated over the identified data object. It also may include transformations that produced the input to the digest operation. A data object is signed by computing its digest value and a signature over that value. The signature is later checked via reference and signature validation. A <Reference> element 808 may be further contain an optional URI that identifies the data object to be signed, as depicted by <Reference URI> tag 808A.

The <Transforms> element 808B contains an optional ordered list of processing steps that were applied to the resource's content before it was digested. Transforms can include operations such as canonicalization, encoding/decoding (including compression/inflation), XSLT, XPath, XML schema validation, or XInclude. XPath transforms permit the signer to derive an XML document that omits portions of the source document. Consequently those excluded portions can change without affecting signature validity. For example, if the resource being signed encloses the signature itself, such a transform must be used to exclude the signature value from its own computation. If no <Transforms> element 808B is present, the resource's content is digested directly. While the Working Group has specified mandatory (and optional) canonicalization and decoding algorithms, user specified transforms are permitted.

The <DigestMethod> element 808C specifies the algorithm applied to the data after the Tranform(s) is/are applied (if specified) to yield the DigestValue defined by the <DigestValue> Element 808D. Signing of the DigestValue is what binds a resources content to the signer's key.

The optional <KeyInfo> element 810 proscribed the key to be used to validate the signature. Possible forms for identification include certificates, key names, and key agreement algorithms and information. KeyInfo is optional for two reasons. First, the signer may not wish to reveal key information to all document processing parties. Second, the information may be known within the application's context and need not be represented explicitly. Since KeyInfo is outside of <SignedInfo> element 800, if the signer wishes to bind the keying information to the signature, a Reference can easily identify and include the KeyInfo as part of the signature.

The optional Type attribute (not shown) of a <Reference> element 808 provides information about the resource identified by the URI. In particular, it can indicate that it is an Object, SignatureProperty, or Manifest element. This can be used by applications to initiate special processing of some Reference elements. References to an XML data element within an Object element should identify the actual element pointed to. Where the element content is not XML (perhaps it is binary or encoded data) the reference should identify the Object and the Reference Type.

The Manifest element is provided to meet additional requirements not directly addressed by the mandatory parts of the specification. Two requirements and the way the Manifest satisfies them follow.

First, applications frequently need to efficiently sign multiple data objects even where the signature operation itself is an expensive public key signature. This requirement can be met by including multiple Reference elements within SignedInfo since the inclusion of each digest secures the data digested. However, some applications may not want the core validation behavior associated with this approach because it requires every Reference within SignedInfo to undergo reference validation—the DigestValue elements are checked. These applications may wish to reserve reference validation decision logic to themselves. For example, an application might receive a signature valid SignedInfo element that includes three Reference elements. If a single Reference fails (the identified data object when digested does not yield the specified DigestValue) the signature would fail core validation. However, the application may wish to treat the signature over the two valid Reference elements as valid or take different actions depending on which fails. To accomplish this, SignedInfo would reference a Manifest element that contains one or more Reference elements (with the same structure as those in SignedInfo). Then, reference validation of the Manifest is under application control.

Second, consider an application where many signatures (using different keys) are applied to a large number of documents. An inefficient solution is to have a separate signature (per key) repeatedly applied to a large SignedInfo element (with many References); this is wasteful and redundant. A more efficient solution is to include many references in a single Manifest that is then referenced from multiple Signature elements.

Core generation under the XML Signature specification involves two operations: generation of reference elements and the SignatureValue over SignedInfo.

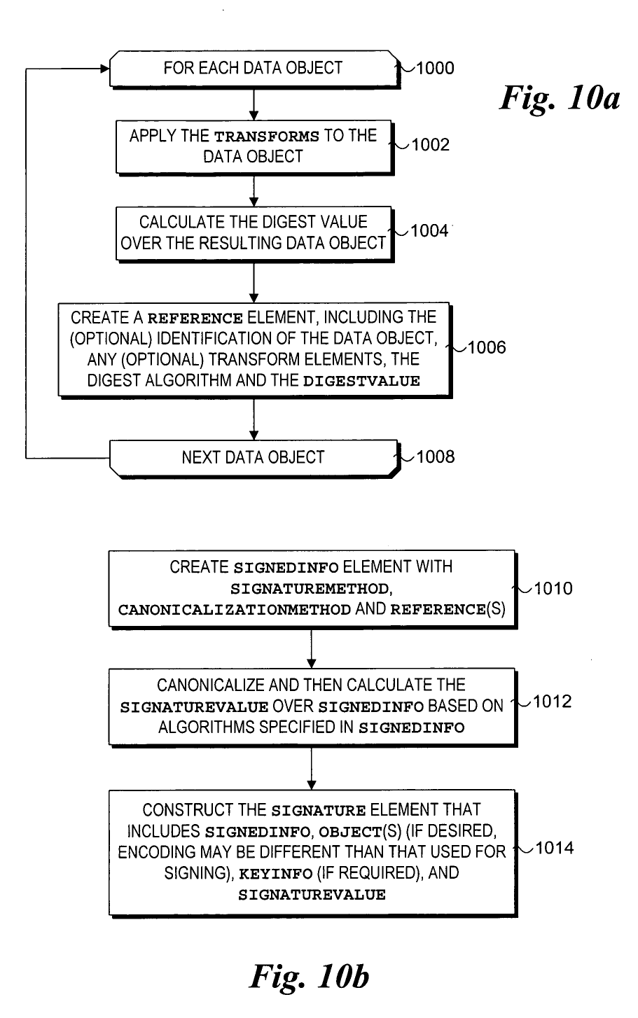

Details of operations performed during the generation of reference elements according to one embodiment are shown in the flowchart of FIG. 10a. As shown by start and end loop blocks 1000 and 1008, the operations in blocks 1002, 1004, and 1006 are performed for each data object being signed. In block 1002, the Transforms, as determined by the application, are applied to the data object. The digest value over the resulting data object is then calculated in block 1004. Next, a Reference element is created in a block 1006, which may include an optional identification of the data object and/or any transform elements, and includes the digest algorithm and the DigestValue.

A flowchart illustrating the operations performed during generation of the SignatureValue over SignedInfo according to one embodiment are shown in FIG. 10b. The process begins in a block 1010, wherein a SignedInfo element is created with the SignatureMethod, CanonicalizationMethod, and Reference(s). This result is then Canonicalized, and the SignatureValue over SignedInfo is calculated based on the algorithms specified in SignInfo, as depicted by a block 1012. The Signature element is then constructed in a block 1014. The Signature element includes SignedInfo, Object(s) (possibly having optional encoding that may differ from that used for signing), any required KeyInfo, and the SignatureValue.

The other half of the scheme concerns core validation. Core validation comprises two steps, including (1) reference validation, the verification of the digest contained in each Reference in SignInfo, and (2) the cryptographic signature validation of the signature calculated over SignedInfo. Comparison of values in reference and signature validation are over the numeric (e.g., Integer) or decoded octet sequence of the value. Different implementations may produce different encoded digest and signature values when processing the same resources because of variances in their encodings, such as accidental white space; these problems will be avoided by using numeric or octet comparison on both the stated and computed values.

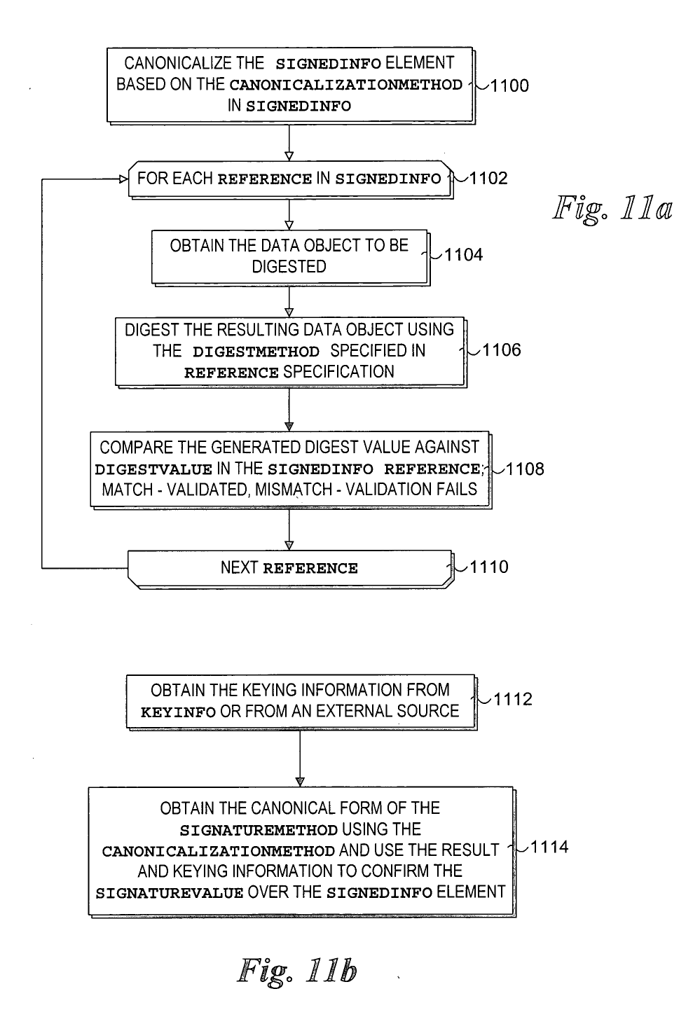

With reference to the flowchart of FIG. 11a, reference validation begins in a block 1100, wherein the SignedInfo element is canonicalized based on the CanonicalizationMethod in SignedInfo. The operations of blocks 1104, 1106, and 1108 delineated by start and end loop blocks 1102, and 1110 are performed for each Reference in SignedInfo. In block 1104 the data object to be digested is obtained. For example, the signature application may dereference the URI and execute Transforms provided by the signer in the Reference element, or it may obtain the content through other means such as a local cache.

Next, in block 1106 a digest on the resulting data object is generated using the DigestMethod specified in its Reference specification. The generated digest value is then compared against the DigestValue in the SignedInfo Reference. If it matches, validation is made; if not, validation fails.

The signature validation operations according to one embodiment are shown in FIG. 11b. In a block 1112, the keying information is obtained from KeyInfo or from an external source. The canonical form of the SignatureMethod is then obtained in a block 1114, using the CanonicalizationMethod. The result is then used, along with the keying information to confirm the Signature over the SignedInfo element.

A companion piece to the XML Signature Syntax and Processing (XML-Sig) specification is the XML Key Management Specification (XKMS). The XKMS specification specifies protocols for distributing and registering public keys, suitable for use in conjunction with the XML-Sig specification. It includes two parts: The XML key Information Service Specification (X-KISS) and the XML Key Registration Service Specification (X-KRSS).

The X-KISS specification defines a protocol for a Trust service that resolves public key information contained in XML-SIGelements. The X-KISS protocol allows a client of such a service to delegate part or all of the tasks required to process <ds:KeyInfo> elements. A key objective of the protocol design is to minimize the complexity of application implementations by allowing them to become clients and thereby to be shielded from the complexity and syntax of the underlying PKI used to establish trust relationships. The underlying PKI may be based upon a different specification such as X.509/PKIX, SPKI or PGP.

The X-KRSS specification defines a protocol for a web service that accepts registration of public key information. Once registered, the public key may be used in conjunction with other web services including X-KISS.

Both protocols are defined in terms of structures expressed in the XML Schema Language, protocols employing the Simple Object Access Protocol (SOAP) v1.1 [SOAP] and relationships among messages defined by the Web Services Definition Language v1.0 [WSDL]. Expression of XKMS in other compatible object encoding schemes is also possible.

X-KISS allows a client to delegate part or all of the tasks required to process XML Signature <ds:KeyInfo> elements to a Trust service. A key objective of the protocol design is to minimize the complexity of applications using XML Signature. By becoming a client of the trust service, the application is relieved of the complexity and syntax of the underlying PKI used to establish trust relationships, which may be based upon a different specification such as X.509/PKIX, SPKI or PGP.

By design, the XML Signature Specification does not mandate use of a particular trust policy. The signer of a document is not required to include any key information but may include a <ds:KeyInfo> element that specifies the key itself, a key name, X.509 certificate, a PGP Key Identifier etc. Alternatively, a link may be provided to a location where the full <ds:KeyInfo> information may be found.

X-KRSS describes a protocol for registration of public key information. A client of a conforming service may request that the Registration Service bind information to a public key. The information bound may include a name, an identifier or extended attributes defined by the implementation.

The key pair to which the information is bound may be generated in advance by the client or, to support key recovery, may be generated on request by the service. The Registration protocol may also be used for subsequent recovery of a private key

The protocol provides for authentication of the applicant and, in the case that the key pair is generated by the client, Proof of Possession (POP) of the private key. A means of communicating the private key to the client is provided in the case that the private key is generated by the Registration Service.

In the XML Signature Specification, a signer may optionally include information about his public signing key (“<ds:KeyInfo>”) within the signature block. This key information is designed to allow the signer to communicate “hints” to a verifier about which public key to select. Another important property of <ds:KeyInfo> is that it may or may not be cryptographically bound to the signature itself. This allows the <ds:KeyInfo> to be substituted or supplemented without “breaking” the digital signature.

In recognizing different applications may require different levels of authentication service desired, the XKMS specification defines a tiered implementation model via which application may select a level of processing appropriate to its needs. Each level supports retrieval of information from remote resources.

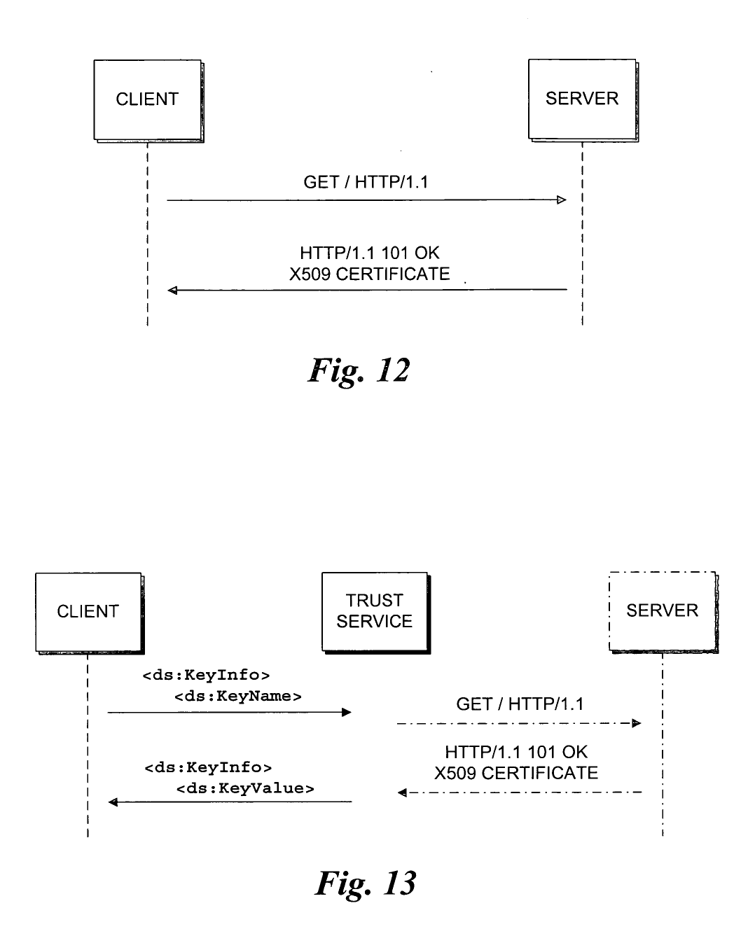

FIG. 12 shows an architecture corresponding to the most basic level of service—Tier 0:<ds:RetrievalMethod> Processing. Under this scheme, a <ds:KeyInfo> element may include a <ds:RetrievalMethod> element (defined by the XML-SIG specification) that is a means to convey information available from a remote location. For example, the signer of a document may wish to refer verifiers to a chain of X.509 certificates without having to attach them. The <ds:RetrievalMethod> element consists of a location from which the certificate chain may be retrieved, a method, and a type.

The XML Signature Specification defines the <ds:KeyInfo> <ds:RetrievalMethod> as follows: A RetrievalMethod element within Keyinfo is used to convey a reference to Keyinfo information that is stored at another location. For example, several signatures in a document might use a key verified by an X.509v3 certificate chain appearing once in the document or remotely outside the document; each signature's Keyinfo can reference this chain using a single <ds: RetrievalMethod> element instead of including the entire chain with a sequence of X509Certificate elements. The RetrievalMethod uses the same syntax and dereferencing behavior as Reference's URI and the Reference Processing Model, except that there is no DigestMethod or DigestValue child elements and presence of the URI is mandatory.

The schema definition is shown below:

```
<element name=“RetrievalMethod”>
    <complexType>
        <sequence>
            <element ref=“ds:Transforms” minOccurs=“0”/>
        </sequence>
        <attribute name=“URI” type=“uriReference”/>
        <attribute name=“Type” type=“uriReference”
use=“optional”/>
    </complexType>
</element>
```

In the following example, the signer indicates a web-resident directory service (www.PkeyDir.test) where they have published information about their public key.

```
<ds:KeyInfo>
    <ds:RetrievalMethod URI=“http://www.PKeyDir.test/CheckKey”
        Type=“http://www.w3.org/2000/09/xmldsig#X509Certificate”/>
</ds:KeyInfo>
```

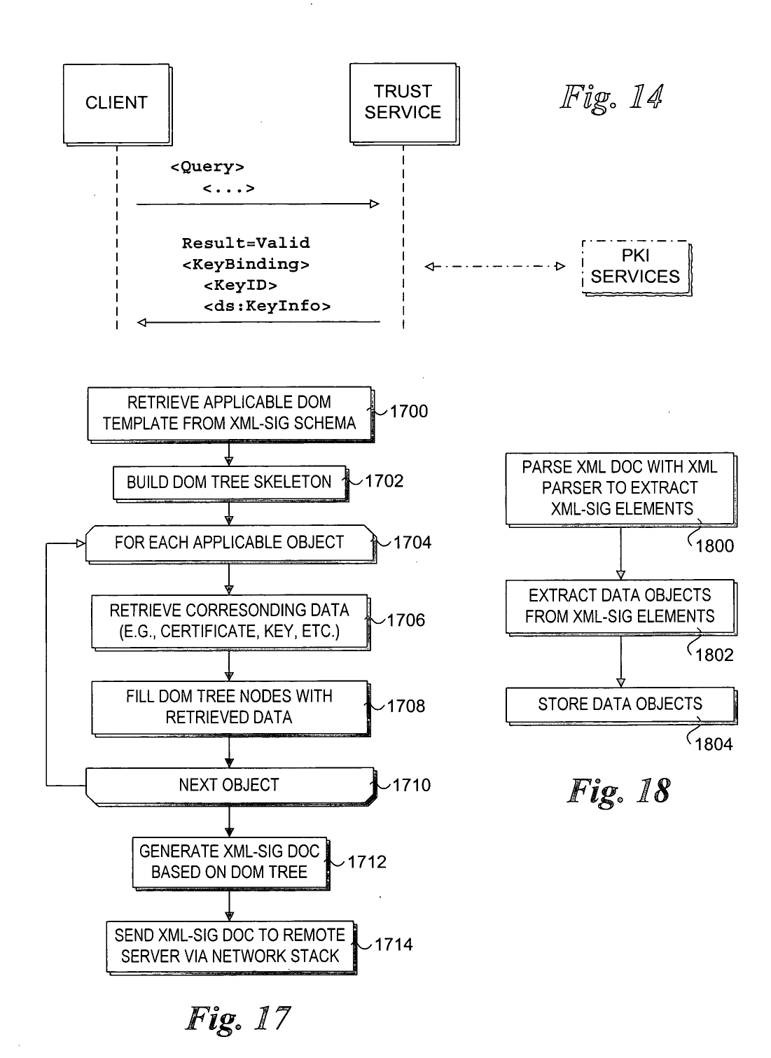

The Tier 1 Locate service resolves a <ds:Keyinfo> element but does not require the service to make an assertion concerning the validity of the binding between the data in the <ds:Keyinfo> element. The Trust service may resolve the <ds:Keyinfo> element using local data or may relay request to other servers. For example the Trust service might resolve a <ds:RetrievalMethod> element, such as shown in FIG. 13 or act as a gateway to an underlying PKI based on a non-XML syntax. Both the request and/or the response may be signed, to both authenticate the sender and protect the integrity of the data being transmitted, using an XML Signature.

One example of a Tier 1 service is used for document signatures. For example, The client receives a signed XML document. The <ds:Keyinfo> element specifies a <ds:RetrievalMethod> for an X.509 certificate that contains the public key. The client sends the <ds:Keyinfo> element to the location service requesting that the <KeyName> and <KeyValue> elements be returned. An exemplary Request looks like:

```
<Locate>
    <Query>
        <ds:KeyInfo>
            <ds:RetrievalMethod
              URI=“http://www.PKeyDir.test/Certificates/01293122”
              Type=“http://www.w3.org/2000/09/
              xmldsig#X509Data”/>
        </ds:KeyInfo>
    </Query>
    <Respond>
        <string>KeyName</string>
        <string>KeyValue</string>
    </Respond>
</Locate>
```

The location service resolves the <ds:RetrievalMethod>, obtaining an X.509v3 certificate. The certificate is parsed to obtain the public key value that is returned to the client. The KeyName> returned is obtained from the certification. An exemplary response looks like:

```
<LocateResult>
    <Result>Success</Result>
    <Answer>
        <ds:KeyInfo>
            <ds:KeyName>O=XMLTrustCernter.org OU=“Crypto”
                CN=“Alice”</ds:KeyName>
            <ds:KeyValue>...</ds:KeyValue>
        </ds:KeyInfo>
    </Answer>
</LocateResult>
```

The Tier 2 Validate Service includes all of the Tier 1 services, plus enables the client to obtain an assertion specifying the status of the binding between the public key and other data, for example a name or a set of extended attributes. Furthermore the service represents that the status of each of the data elements returned is valid and that all are bound to the same public key. The client sends to the trust service a prototype containing some or all of the elements for which the status of the trust binding is required. If the information in the prototype is incomplete, the trust service may obtain additional data required from an underlying PKI Service. Once the validity of the Key Binding has been determined the Trust service returns the status result to the client. An example of a Tier 2 key validation service is shown in FIG. 14.

Under the foregoing document signature example (as now applied to the Tier 2 validate service), the client has verified the document signature. The client now needs to determine whether the binding between the name and the public key is both trustworthy and valid. An exemplary request looks like:

```
<Validate>
    <Query>
        <Status>Valid</Status>
        <ds:KeyInfo>
            <ds:KeyName>...</ds:KeyName>
            <ds:KeyValue>...</ds:KeyValue>
        </ds:KeyInfo>
    </Query>
    <Respond>
        <string>KeyName</string>
        <string>KeyValue</string>
    </Respond>
</Validate>
```

An exemplary response looks like:

```
<ValidateResult>
    <Result>Success</Result>
    <Answer>
        <KeyBinding>
            <Status>Valid</Status>
            <KeyID>http://www.xmltrustcenter.org/assert/20010120-
39</KeyID>
            <ds:KeyInfo>
                <ds:KeyName>...</ds:KeyName>
                <ds:KeyValue>...</ds:KeyValue>
            </ds:KeyInfo>
            <ValidityInterval>
                <NotBefore>2000-09-20T12:00:00</NotBefore>
                <NotAfter>2000-10-20T12:00:00</NotAfter>
            </ValidityInterval>
        </KeyBinding>
    </Answer>
</ValidateResult>
```

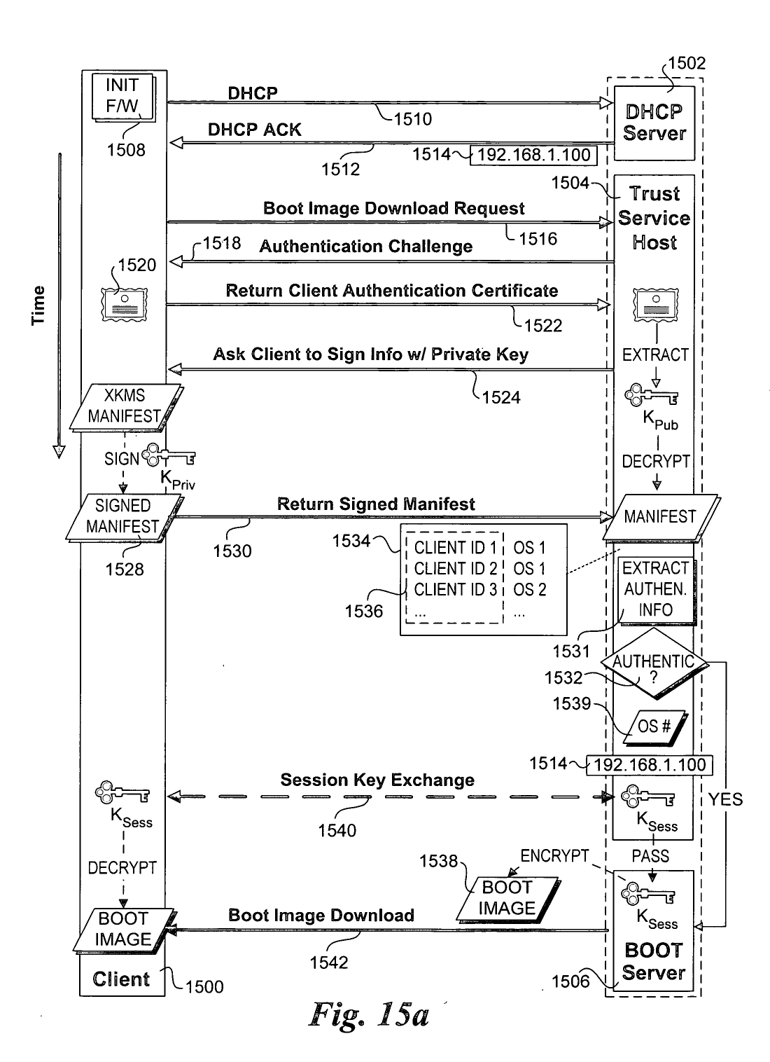

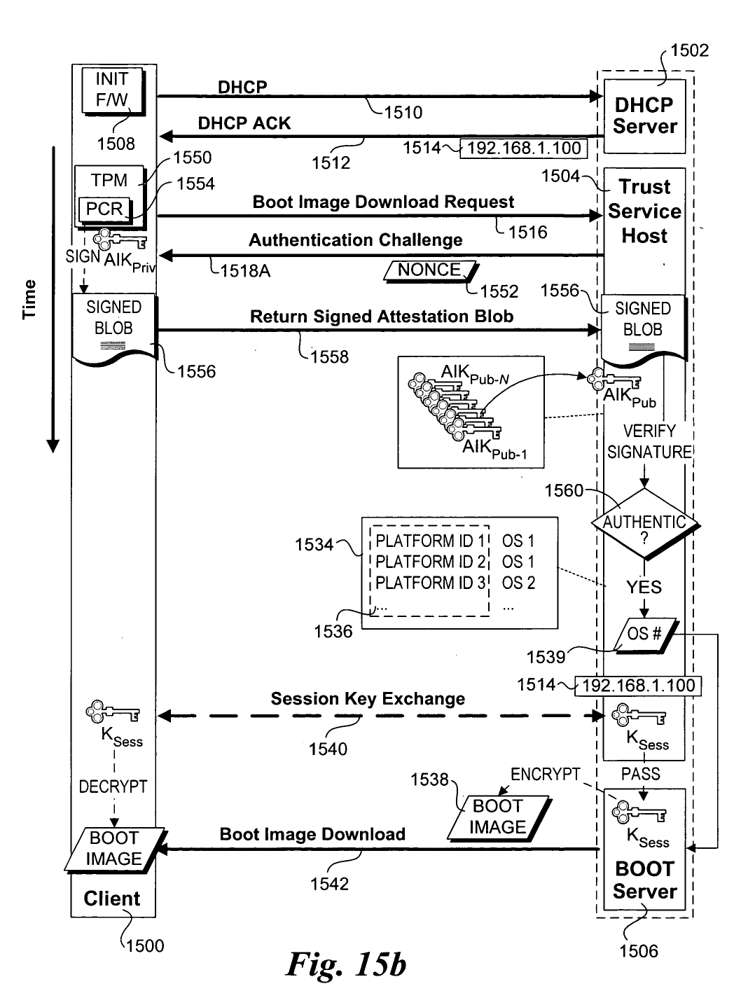

An exemplary booting process under which a local system is authenticated prior to receiving a bootable image in accordance with one embodiment is depicted in FIG. 3. The process involves a series of message exchanges between a client 1500 (i.e., the local system), a DHCP (Dynamic Host Configuration Protocol) server 1502, and a trust service host 1504, and a boot server 1506. Under various embodiments, the operations provided by DHCP server 1502, trust service host 1504, and boot server 1506 may be hosted by three separate machines coupled via a network, two machines coupled via a network, or a single machine, coupled to client 1500 via a network. In one embodiment, client 1500 is connected to one or both of trust service host 1504 and boot server 1506 via the Internet. The series of message exchanges illustrated in FIG. 15 correspond to operations that are performed in response to a system restart or reset event.

First, a portion of system firmware 1508 is executed on client 1500 to perform early initialization of the board, including enabling basic network communications. These operations are analogous to those shown in FIG. 2 and discussed above.

The next set of operations involves an exchange of messages between client 1500 and DHCP server 1502 to obtain an network (e.g., IP (Internet Protocol) address. For simplicity, this message exchange is depicted as a PXE DHCP IP address request 1510 and a DHCP acknowledge 1512. In practice, the series of communications exchanges comprises the following:
1. The client broadcasts a DHCP_Discover message on its local sub-net searching for DHCP server;
2. A listening DHCP server (coupled to the sub-net or to another network to which the sub-net is connected) sends a DHCP_Offer message containing an offered address to the client;
3. The client accepts the offered IP address and broadcasts a DHCP_Request message on the local sub-net (which may be forwarded to an attached network) containing the accepted IP address; and
4. The DHCP server responds via a unicast to the client board with a DHCP_Ack message to acknowledge the EP address has been accepted.

The foregoing illustrates a sequence under which a single DHCP server receives the DHCP_Discover message. Under some circumstances, multiple DHCP servers may receive the DHCP_Discover message, and offer respective IP addresses in response. Under this circumstance, the client will select one of the offered IP addresses. The net result is that the client board will end up with an IP address 1514. The particular address is not important, and will generally relate to the IP address scope allotted to the DHCP server by an administrator. At this point, the client 1500 can communicate with other network entities via unicasts rather than broadcasts.

The next portion of message exchanges is between the client 1500 and the Trust service host 1504 (or a co-located DHCP server/trust service host). The address of the trust service may be known in advance by the client (e.g., setup by a system administrator or the like), or provided by DHCP server 1502. This process begins with a boot image download request message 1516 sent from client 1500 to trust service host 1504. In response, the trust service issues an authentication challenge 1518. This challenge can be in one of many forms well-known in the security and encryption arts.

In the embodiment of FIG. 15a, client 1500 responds to the authentication challenge by sending an authentication certificate 1520 in an XML-SIG message 1502. In their simplest form, authentication certificates contain a public key and a name. As commonly used, a certificate also contains an expiration date, information identifying the certifying authority that issued the certificate (e.g., a platform vendor or trusted third party (TTP)), a unique identifier (e.g., serial number), and perhaps other information. A certificate also contains a digital signature of the certificate issuer. The most widely accepted format for certificates is defined by the ITU (International Telecommunications Union)—T X.509 international standard (version 3 is the current version). Other certificates, such as but not limited to PGP (Pretty Good Privacy) and SPKI (Simple Public Key Infrastructure), may also be used.

The XML-SIG message 1522 is configured in accordance with the XML-SIG schema definition, wherein an authentication certificate is embedded within a corresponding certificate element. For example, in one embodiment, the authentication certificate comprises an X.509 version 3 certificate, and the corresponding schema element comprises an X509Data element. In other embodiments, the certificate corresponds to a PGP certificate and a SPKI certificate, respectively, and respective schema elements of PGPData and SPKIData are employed. Authentication certificate 1520 will typically be provided by a trusted third party (TTP), a manufacturer, or a system administrator, although other certificate provisioning may also be used.

Upon receiving authentication certificate 1520, its public key K_{Pub} is extracted by the trust service. As an optional operation, the trust service may check the validity of the certificate (e.g., to verify it hasn't been revoked or deactivated, etc.). The trust service then sends a message 1524 asking the client to sign some information with the client's private key K_{Priv}, which is the asymmetric key for public key K_{Pub}. In one embodiment, client 1500 signs an XKMS manifest 1526 that was extracted or retrieved in the manner discussed in block 218 of FIG. 2 above. The signed manifest 1528 is then returned to trust service host 1504 in an XML-SIG message 1530.

Upon receiving the signed manifest 1528, the trust service host employs public key K_{Pub} to authenticate the signature. Authentication information contained in the manifest is then extracted in a block 1531 and compared to authentication information stored by the trust service host to authentic the client, as depicted by a decision block 1532. In one embodiment, the authentication information is contained in a boot table 1534 that includes an access control list (ACL) 1536 defining a list of authorized clients and a corresponding boot image that is to be downloaded for each authorized client.

If the client is authenticated, information is passed to boot server 1506 (if hosted by a separate machine that the trust service) to download a bootable image 1538 to client 1500. In one embodiment, the boot server is stored on a remote network to which client 1500 is coupled via a WAN or the Internet. In the case of the Internet or an otherwise unsecure network, session keys K_{Sess} may be exchanged or agreed upon prior to downloading boot image 1538, as depicted by an XML-SIG message exchange 1540. In this instance, trust service host 1504 passes its session key K_{Sess} to boot server 1506, along with information 1539 identifying which boot image to download and the IP address 1514 issued above for the client. The boot server may then encrypt the boot image with the session key, and send the encrypted boot image 1538 to client 1500 via a download data transfer 1542. Upon receipt, encrypted boot image 1538 is decrypted with the client's session key.

An alternative client authentication and boot process in accordance with one embodiment is shown in FIG. 15b. Many of the operations shown in FIG. 15b are analogous to operations shown in FIG. 15a having the same reference numbers. In this instance, client attestation is provided via an attestation identity key pair (AIK_{Priv} and AIK_{Pub}) that is generated by a TPM 1550 hosted by client 1500. A TPM is a small passive device with some non-volatile memory. When ownership of a TPM is taken, a Storage Root Key (SRK) is generated by the TPM and protected inside of it. A unique TPM Endorsement Key (EK) is also generated. The EK enables machine authentication and creates a foundation for attestation (authentication+integrity).

A TPM can be used to create multiple AIKs, which are aliases of the EK. However, an AIK is not linked to an EK, and does not require any Personal Identifying Information (PII). It may be used to attest to platform properties and/or integrity metrics information. The TPM schema supports a mechanism to demonstrate to a third party that an AIK is a valid TPM AIK without associating it to a specific TPM. This supports a secure infrastructure security credentials may be provided without explicitly identifying the source, lessening the vulnerability to attacks.

In response to receiving a boot image download request message 1516, trust service host 1504 returns an authentication challenge message 1518A that includes a nonce 1552. Under security measures, nonces are used to ensure replay attacks and the like cannot be successful. A nonce is typically a one-time use parameter or value that should be unique or random. Typical examples of nonces include random numbers, timestamps, random sequences, etc.

Another function performed by a TPM is configuration information storage. A TPM may store various configuration information in one or more Platform Configuration Registers (PCR). A PCR is a 160-bit shielded storage location for storing discrete information, such as platform configuration and integrity measurements. In the illustrated embodiment of FIG. 15b, platform configuration information, including a platform identity in one embodiment, is stored in a PCR 1554.

In response to the authentication challenge, in one embodiment client 1500 creates a signed blob comprising the platform configuration information in PCR 1554 concatenated with the nonce 1552. The blob is signed with the client's AIK private key AIK_{Priv}. This produces a signed attestation blob 1556. In another embodiment, the PRC 1554 value and/or the nonce may be encrypted with the AIK_{Priv} key. In yet another embodiment, a PCR value signed with the AIK_{Priv} key may be further encrypted with the nonce. The data created in any of these other embodiments is referred to as the attestation data.

In the illustrated embodiment, the signed attestation blob 1556 is returned to trusted service host 1504 in response to the authentication challenge as an XML-SIG message 1558. In other non-illustrated embodiments, the attestation data is returned to the trust service host.

Upon receipt, signed attestation blob 1556 (or the attestation data) is processed to authenticate the client. In one embodiment, trust service host 1504 stores various public “halves” of AIKs, as depicted by AIK_{Pub1-N}. An appropriate public AIK is retrieve to verify the signature of the signed attestation blob. If a private AIK was used to encrypt attestation data, the corresponding public AIK will be used to decrypt it. In one embodiment, attestation data identifying client 1500 is used to determine which operating system version should be downloaded to client 1500 if the client passes the authentication operation depicted by decision block 1560. In another embodiment (not shown), information liking a public AIK to a corresponding platform is used to identify client 1500. In some embodiments, the platform configuration information is used to identify the appropriate OS version, but does not identify the client. At this point, the remaining operations are substantially similar to those discussed above with reference to FIG. 15a.

The foregoing operations shown in FIGS. 15a and 15b were used to authenticate a client via a trust service. Similar operations may be used to authenticate a boot server (if remotely located from the trust service host), resulting in mutual authentication. In this instance, the use of XML-SIG message exchanges is optional, as both the trust service host and the boot server will be running in an OS runtime phase.

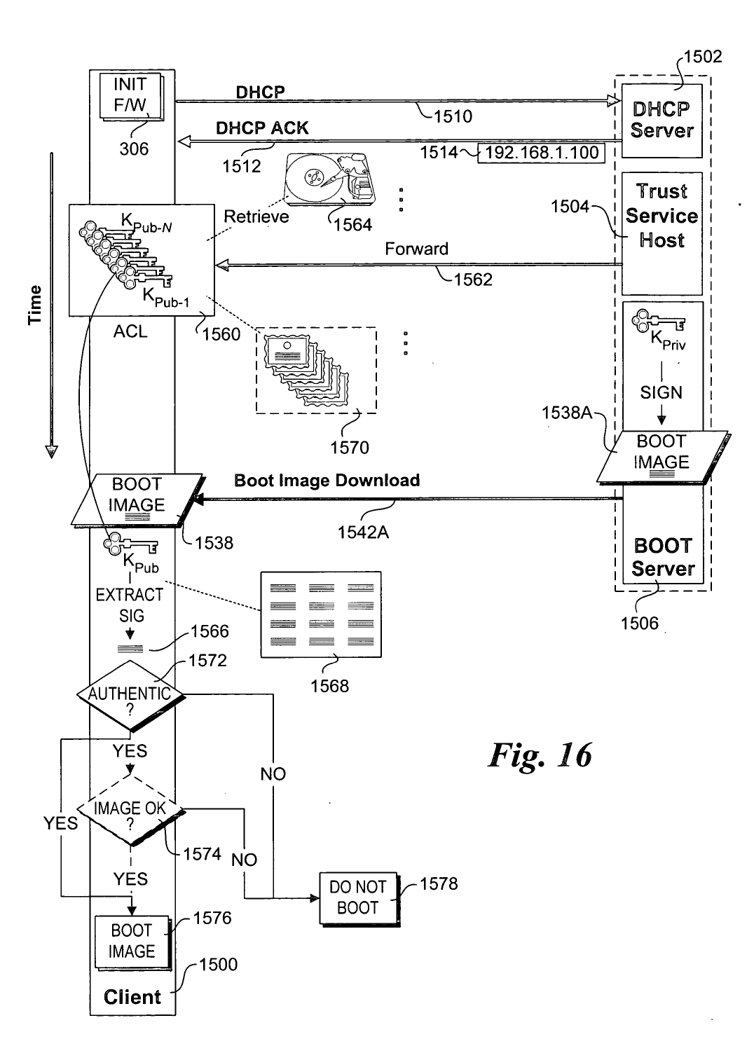

In addition to mutual authentication via a trust service, a client can also provide measures to ensure that the downloaded OS image is provided by a trusted boot server, and has not been tampered with. For example, FIG. 16 shows a scheme for verifying the authenticity of a downloaded boot image. It will be recognized that many of the operations shown in either FIG. 15a or 15b, as well as other pre-boot client authentication schemes, will have been performed prior to the timeframe shown in FIG. 16, or may be performed in a manner that is intermixed with the timeframe of FIG. 16.

The embodiment of FIG. 16 provides authentication of the boot server 1506 and verification that the received boot image has not been tampered with. In one embodiment, boot server authentication is provided via an access control list 1560 that is either provided to client 1500 via an XML-SIG message 1562 or retrieved from a local store 1564. In general, local store 1564 may comprise any storage device one which the ACL may be stored, including but not limited to a disk drive (depicted), a non-volatile memory device, an optical drive, a tape drive, etc.

In one embodiment, ACL 1560 comprises a set of public keys K_{Pub1-N}. An asymmetric private key KPriv for each public key KPub is stored at a respective boot server 1506. In essence, each key in ACL 1560 correlates to a boot server from which client 1500 is authorized to boot. Typically, the access control list will be set up by a system administrator or the like prior to client system use.

The asymmetric key pairs may be used to authenticate the source of an image, i.e., a boot server 1506. In one embodiment, a private key KPriv is used to sign a boot image, yielding a signed boot image 1538A. The signed boot image is then transferred to client 1500 via a download data transfer 1542A. Upon receipt of the signed image, an appropriate public key KPub is retrived from ACL 1560 and used to extract a signature 1566. The signature is then checked to see if it corresponds to an authorized boot source. In one embodiment, this is performed by seeing if the signature matches a signature in an authorization table 1568. In another embodiment, the mere fact that the signature could be extracted provides authentication of the signature. In another embodiment, ACL 1560 contains a set of certificates 1570, each including a respective KPub and respective signature or similar data from which the extracted signature can be authenticated. The result of this signature authentication is depicted by a decision block 1572.

In one embodiment, the image is also verified in accordance with a decision block 1574 to verify the image has not been tampered with. This is typically done by performing a hash on the image and comparing the hash result to a hash result performed on a known valid image. The known hash result may be provided to client 1500 from one or trust service host 1504, boot server 1506, or a trusted third party (TTP), or it may be retrieved from a local store.

If the answer to decision block 1572 is YES (and optionally, if an image validity check is to be made, the answer to decision block 1574 is also YES), the boot image is booted in a block 1576. If the image source cannot be authenticated (or the image validity check is not confirmed), the image is not booted, as depicted by a block 1578.

As discussed above, various authentication data is transferred between a client and a server via an exchange of XML-SIG messages. FIG. 17 shows a flowchart illustrating operations performed when generating an XML-SIG message, according to one embodiment. The process begins in a block 1700, in which an applicable DOM template is retrieved from XML-SIG schema 111. The DOM template will comprise a portion of the XML-SIG schema applicable to a selected message, such as passing certificates, keys, response messages, etc. In general, smaller schemas may be stored in a non-persistent store (e.g., a firmware store), while larger schemas will typically be retrieved from a mass storage device and loaded into system memory. In one embodiment, the XML-Schema 111 and/or the XML key management schema 112 may be loaded into memory from a network store.

The DOM template defines a DOM tree structure that is used to build a skeletal tree in a block 1702. In one embodiment, the skeletal tree mirrors the structure of a selected XML-SIG message, with each message hierarchy element occupying respective DOM branch and sub-branch objects. The reason for the “skeletal” reference is because at this point in time the DOM tree only contains element outlines, with no data elements pertaining to the message objects.

Dom tree message objects may be derived from the local store, or may have been previously provided from a remote store (such as a trust service host). In one embodiment, all or a portion of the DOM tree message objects are stored in XML key management schema 112.

The next set of operations in the loop defined by start and end loop blocks 1704 and 1710 are used to populate the skeletal DOM tree with data (i.e., message object). For each applicable object, corresponding data is retrieved in a block 1706. For example, if an XML-SIG message is to contain certificate information, data relating to one or more corresponding certificates is retrieved. Appropriate DOM tree nodes are then filled with the retrieved data in a block 1708. In one embodiment, the operations of blocks 1706 and 1708 are performed on the fly. In another embodiment, the various data may be temporarily stored in a pre-configured data structure, wherein the DOM tree nodes are filled by retrieving data from the data structure in one operations rather than iteratively as depicted in FIG. 17.

After the DOM tree nodes have been filled, the XML-SIG document corresponding to the selected message is generated in a block 1712. The XML-SIG document is then sent as an XML-SIG message to a remote server host via network stack 120.

FIG. 18 shows a flowchart illustrating operations performed when processing a received XML-SIG message, according to one embodiment. Prior to the operations shown, the XML-SIG message will be received via an appropriate transport (e.g., HTTP over TCP/IP) and pass through network stack 120, where it is received at XML ConIn( ) interface 108. As shown by a block 1800, the XML doc is then parsed with XML parser 102 to extract the XML-SIG elements. Data objects encapsulated in the extracted elements are then extracted in a block 1802 and stored in a block 1804. Typically, the data objects will be stored in system memory, but they may be stored on other storage means as well. The data objects can then be examined, manipulated, etc. by firmware to formulate the next message.

Embodiments of the invention provide system security functionality that enables interaction with remote servers and the like. In particular, the remote server may be connected to a client system via a LAN, a WAN, or even the Internet. This provides great flexibility for IT deployment, especially for companies with geographically-dispersed computing infrastructure. For example, such a company could deploy a trust service via an Internet site that could marshal trust service interaction with client systems at any location from which the Internet may be accessed. One or more boot servers could be connected to the LAN, WAN or Internet in a similar manner. Secure access to the boot servers (and authentication of clients as well) are supported by the embodiments discussed herein.

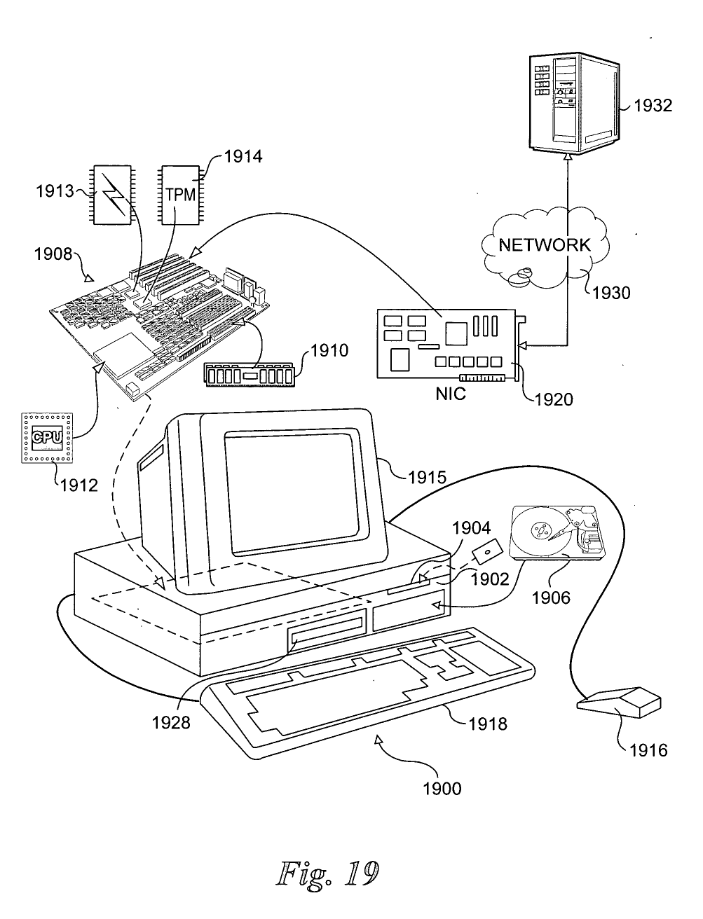

FIG. 19 illustrates an embodiment of an exemplary computer system 1900 to practice embodiments of the invention described above. Computer system 1900 is generally illustrative of various types of computer devices, including personal computers, laptop computers, workstations, servers, etc. For simplicity, only the basic components of the computer system are discussed herein. Computer system 1900 includes a chassis 1902 in which various components are housed, including a floppy disk drive 1904, a hard disk 1906, a power supply (not shown), and a motherboard 1908. Hard disk 1906 may comprise a single unit, or multiple units, and may optionally reside outside of computer system 1900. The motherboard 1908 includes memory 1910 coupled in communication with one or more processors 1912 via appropriate busses and/or chipset components. Memory 1910 may include, but is not limited to, Dynamic Random Access Memory (DRAM), Static Random Access Memory (SRAM), Synchronized Dynamic Random Access Memory (SDRAM), Rambus Dynamic Random Access Memory (RDRAM), or the like. Processor 1912 may be a conventional microprocessor including, but not limited to, a CISC (complex instruction set computer) processor, such as an Intel Corporation x86, Pentium®, or Itanium® family microprocessor, a Motorola family microprocessor, or a RISC (reduced instruction set computer) processor, such as a SUN SPARC processor or the like.

The computer system 1900 also includes one or more non-volatile memory devices on which firmware for effectuating all or a portion of the XML-based security services is stored. Such non-volatile memory devices include a flash device 1913. Other non-volatile memory devices include, but are not limited to, an Erasable Programmable Read Only Memory (EPROM), an Electronically Erasable Programmable Read Only Memory (EEPROM), or the like. The computer system 1900 may include other firmware devices as well (not shown).

In one embodiment, a TPM 1914 is operatively coupled to motherboard 1708. In one embodiment, TPM 1914 is mounted on the motherboard. In an optional configuration, the TPM is coupled in communication with the motherboard via a dongle or the like (not shown).

A monitor 1915 is included for displaying graphics and text generated by firmware, software programs and program modules that are run by computer system 1900. For example, in one embodiment a user may enter a userID and password to authenticate the client; a screen corresponding to enable this process may be displayed on the monitor during the pre-boot. A mouse 1916 (or other pointing device) may be connected to a serial port, USB (Universal Serial Bus) port, or other like bus port communicatively coupled to processor 1912. A keyboard 1918 is communicatively coupled to motherboard 1908 in a similar manner as mouse 1916 for user entry of text and commands.

In one embodiment, computer system 1900 also includes a network interface card (NIC) 1920 or built-in NIC interface (not shown) for connecting computer system 1900 to a computer network 1930, such as a local area network (LAN), wide area network (WAN), or the Internet. In one embodiment, network 1930 is further coupled to a remote computer 1932, such that computer system 1900 and remote computer 1932 can communicate. In one embodiment, a portion of the computer system's firmware and/or pre-boot environment data is loaded during system boot from remote computer 1932. For example, data corresponding to XML-SIG schema 111 and/or XML key management schema 112 may be stored on remote computer 1932 and loaded into memory 1910 during the pre-boot.

Computer system 1900 may also optionally include a compact disk-read only memory (“CD-ROM”) drive 1928 into which a CD-ROM disk may be inserted so that executable files, such as an operating system, and data on the disk can be read or transferred into memory 1910 and/or hard disk 1906. Other mass memory storage devices may be included in computer system 1900.

In another embodiment, computer system 1900 is a handheld or palmtop computer, which are sometimes referred to as Personal Digital Assistants (PDAs). Handheld computers may not include a hard disk or other mass storage, and the executable programs are loaded from a corded or wireless network connection into memory 1910 for execution by processor 1912. A typical computer system 1900 will usually include at least a processor 1912, memory 1910, and a bus (not shown) coupling the memory 1910 to the processor 1912.

It will be appreciated that in one embodiment, computer system 1900 is controlled by operating system software that includes a file management system, such as a disk operating system, which is part of the operating system software. For example, one embodiment of the present invention utilizes a Microsoft Windows® operating system for computer system 1900. In another embodiment, other operating systems such as, but not limited to, an Apple Macintosh® operating system, a Linux-based operating system, the Microsoft Windows CE® operating system, a Unix-based operating system, the 3Com Palm® operating system, or the like may also be use in accordance with the teachings of the present invention.

Thus, embodiments of this invention may be used as or to support a firmware and software code executed upon some form of processing core (such as processor 1912) or otherwise implemented or realized upon or within a machine-readable medium. A machine-readable medium includes any mechanism that provides (i.e., stores and/or transmits) information in a form readable by a machine (e.g., a computer, network device, personal digital assistant, manufacturing tool, any device with a set of one or more processors, etc.). In addition to recordable media, such as disk-based media, a machine-readable medium may include propagated signals such as electrical, optical, acoustical or other form of propagated signals (e.g., carrier waves, infrared signals, digital signals, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

1. A method comprising:
loading an XML-based interface during a pre-boot phase of a computer system; and
enabling the computer system to perform security operations during the pre-boot phase by passing XML-based security content between the computer system and a remote server via the XML-based interface.

2. The method of claim 1, further comprising performing an exchange of messages with the remote server during the pre-boot phase, wherein at least a portion of the messages are compliant with the XML-Signature Syntax and Processing (XML-SIG) specification and comprise XML-SIG messages.

3. The method of claim 2, wherein the messages are exchanged over the Internet.

4. The method of claim 2, further comprising authenticating the computer system during the pre-boot phase via an exchange of XML-SIG messages.

5. The method of claim 4, further comprising setting up session keys to be used to encrypt messages sent between the computer system and a remote server, wherein the session keys are set up via an exchange of XML-SIG messages.

6. The method of claim 4, wherein the computer system is a client and is authenticated by performing operations including:
issuing an authentication challenge message from the remote server to the client;
returning an authentication certificate for the client to the remote server via an XML-SIG message, said authentication certificate including a public key;
sending a message from the remote server to the client asking the client to sign authentication information with a private key that is an asymmetric key to the public key;
returning signed authentication information that was signed with the private key to the remote server via an XML-SIG message;
using the public key to extract the authentication information; and
verifying an authenticity of the client with the authentication information.

7. The method of claim 6, wherein the authentication information comprises an XML Key Management Specification (XKMS) manifest.

8. The method of claim 4, wherein the computer system is a client and is authenticated by performing operations including:
issuing an authentication challenge message from the remote server to the client;
retrieving a private attestation identify key (AIK) generated by a trusted platform module (TPM) hosted by the client;
employing the private AIK to sign and/or encrypt an attestation blob containing client identify information and sending the attestation blob to the remote server;
using a public AIK corresponding to the private AIK to extract the client identify information from the attestation blob.

9. The method of claim 8, further comprising:
sending a nonce with the authentication challenge message; and
using the nonce to produce the attestation blob.

10. The method of claim 2, further comprising:
obtaining authentication information from which a bootable operating system image may be authenticated;
receiving a bootable operating system image; and
verifying an authenticity of the bootable image via the authentication information.

11. The method of claim 10, further comprising receiving the authentication information in an XML-SIG message sent from a remote server.

12. The method of claim 10, wherein the authentication information comprises an access control list including one or more public keys, each of which may be used to authenticate a boot image signed with a respective corresponding private key.

13. The method of claim 2, further comprising:
storing template information in an XML-SIG schema;
identifying a portion of the XML-SIG schema corresponding to an XML-SIG message that is to be generated;
generating XML content formatted according to a template defined by the portion of the XML-SIG schema that is identified to build the XML-SIG message.

14. The method of claim 13, further comprising loading the XML-SIG schema into memory for the computer system from a local mass storage device during the pre-boot phase.

15. The method of claim 13, further comprising loading the XML-SIG schema into memory for the computer system from a remote network store during the pre-boot phase.

16. The method of claim 1, wherein the method is implemented using firmware components configured in accordance with the extensible firmware interface (EFI) framework standard.

17. A computer system comprising:
a processor;
memory, communicatively coupled to the processor;
a network interface, communicatively coupled to the processor;
at least one storage device communicatively coupled to the processor and having instructions stored thereon, which when executed by the processor perform operations including:
hosting an XML-based interface including XML console in and console out interfaces during a pre-boot phase of the computer system;
setting up a network stack to enable XML content received at the network interface to be forwarded to the XML console in interface and XML content provided at the XML content out interface to be sent out via the network interface; and
enabling the computer system to perform security operations during the pre-boot phase by processing XML-based security content received from a remote server via the network interface and the XML console in interface and generating XML-based security content to be sent to the remote server via the XML console out interface and the network interface.

18. The computer system of claim 17, wherein said at least one storage device comprises a flash device.

19. The computer system of claim 17, wherein execution of the instructions performs the further operations of:
receiving an XML-SIG message having an XML content in accordance with the XML-Signature Syntax and Processing (XML-SIG) specification and including security information;
extracting the security information from the XML-SIG message.

20. The computer system of claim 17, further comprising an XML-SIG schema stored in said at least one storage device, said XML-SIG console schema defining a XML schema in accordance with the XML-Signature Syntax and Processing (XML-SIG) specification.

21. The computer system of claim 17, further comprising an XML key management schema stored in said at least one storage device, said XML key management schema defining a XML schema in accordance with the XML Key Management Specification (XKMS).

22. The computer system of claim 17, wherein execution of the instructions performs the further operations of:
retrieving authentication information; and
generating an XML-SIG message having an XML content in accordance with the XML-Signature Syntax and Processing (XML-SIG) specification and including the authentication information.

23. The computer system of claim 17, wherein the instructions include firmware components that are configured in accordance with the extensible firmware interface (EFI) framework standard.

24. The computer system of claim 17, wherein the network stack includes support for receiving messages from a remote server via the Internet and sending messages to the remote server via the Internet.

25. The computer system of claim 17, further comprising a trusted platform module (TPM) operatively coupled to the processor, the TPM to generate attestation information via which the system may be authenticated.

26. A machine-readable media to provide instructions, which when executed perform operations including:
hosting an XML-based interface including XML console in and XML console out interfaces during a pre-boot phase of the computer system;
setting up a network stack to enable XML content received at the network interface to be forwarded to the XML console in interface and XML content provided at the XML content out interface to be sent out via the network interface; and
enabling the computer system to perform security operations during the pre-boot phase by processing XML-based security content received from a remote server via the network interface and the XML console in interface and generating XML-based security content to be sent to the remote server via the XML console out interface and the network interface.

27. The machine-readable media of claim 26, wherein the XML-based security content and network stack support transfer of data via the Internet.

28. The machine-readable media of claim 26, to provide further instructions that when executed perform operations including:
performing client-side operations to facilitate an exchange of messages with the remote server during the pre-boot phase, wherein at least a portion of the messages are compliant with the XML-Signature Syntax and Processing (XML-SIG) specification and comprise XML-SIG messages.

29. The machine-readable media of claim 28, to provide further instructions that when executed perform operations including:
storing template information in an XML-SIG schema;
identifying a portion of the XML-SIG schema corresponding to an XML-SIG message that is to be generated;
generating XML content formatted according to a template defined by the portion of the XML-SIG schema that is identified to build the XML-SIG message.

30. The machine-readable media of claim 29, to provide further instructions to load the XML-SIG schema into memory for a computer system on which the instructions are to be executed during the pre-boot phase.
